(19) United States
(12) Patent Application Publication
(10) Pub. No.: US 2026/0184323 A1
(43) Pub. Date: Jul. 2, 2026

(54) METHOD AND VEHICLE CONTROL SYSTEM FOR RECOVERING AN AT LEAST PARTIALLY AUTOMATED VEHICLE

(71) Applicant: ZF CV SYSTEMS GLOBAL GMBH, Bern (CH)

(72) Inventors: Julian Van Thiel, Großburgwedel (DE); Daniel Hanslik, Isernhagen (DE)

(21) Appl. No.: 19/129,708

(22) PCT Filed: Nov. 8, 2023
(86) PCT No.: PCT/EP2023/081132

§ 371 Date: May 14, 2025

(30) Foreign Application Priority Data
Nov. 28, 2022 (DE) 10 2022 131 307.7

(51) Int. Cl. B60W 50/029; B60W 10/06; B60W 10/10; B60W 10/18; B60W 10/20

(52) U.S. Cl. CPC B60W 50/029; B60W 10/06; B60W 10/10; B60W 10/182; B60W 10/20; B60W 2556/45; B60W 2710/06; B60W 2710/10; B60W 2710/186; B60W 2710/20

(57) ABSTRACT

A method for recovering at least a partially automated vehicle comprising a vehicle control system is provided. The vehicle control system includes at least a first subunit and a second subunit. The method includes detecting a malfunction in at least part of the first subunit of the vehicle control system. The method checks whether the first subunit is in an emergency operating state, and, based on determining that the first subunit is not in an emergency operating state, transitioning the first subunit or the vehicle control system into an emergency operating state. The vehicle in the emergency operation state is controlled based on the emergency operating state with help from the vehicle control system. A release signal is received via the vehicle control system. The first subunit or the second subunit of the vehicle control system is actuated based on the release signal.

### CROSS REFERENCE TO RELATED APPLICATIONS

This application is a U.S. National Phase application under 35 U.S.C. § 371 of International Application No. PCT/EP2023/081132, filed on Nov. 8, 2023, and claims benefit to German Patent Application No. DE 10 2022 131 307.7, filed on Nov. 28, 2022. The International Application was published in German on Jun. 6, 2024 as WO 2024/115063 A1 under PCT Article 21(2).

### FIELD

The invention relates to a method for recovering an at least partially automated vehicle and to a corresponding vehicle control system.

### BACKGROUND

The automated vehicle may be a partially automated vehicle or a fully automated vehicle. The method according to the invention and the vehicle control system according to the invention are primarily advantageous for vehicles with an automation level according to SAE (Society of Automotive Engineers) of Levels 2 to 5, in particular Level 4 or 5. The higher the level of automation of an automated vehicle, the broader its field of application, particularly in areas that are inaccessible to humans, such as open-pit or underground mines, for example. In such scenarios, it becomes even more important to have a possible method of recovering a vehicle of this kind that does not expose people to danger during a recovery operation. Particularly when there is no driver present, so in the case of a fully automated vehicle, it may be necessary for the fully automated vehicle to be recoverable in an efficient manner.

DE 10 2017 118 537 A1 discloses how an indication of a state of malfunction is received in a vehicle and the indication of the state of malfunction is wirelessly transmitted to a remote server. Furthermore, it is provided that a revised route to a destination is received, based at least in part on the state of malfunction, and the vehicle is operated along the revised route.

DE 10 2017 211 797 A1 discloses that an autonomous vehicle, particularly in the case of a public emergency, communicates with at least one other autonomous vehicle, and either the autonomous vehicle or an external server unit calculates a route to a safe location, wherein the autonomous vehicle then proceeds to the safe location.

DE 10 2018 203 773 B3 discloses a parking lock system of an automatic transmission in a motor vehicle, wherein the parking lock system comprises a parking lock for blocking or releasing an output of the transmission, as well as a spring accumulator for engaging the parking lock, a pressure-actuated release device for disengaging the parking lock, an operating device for inputting commands, and an information system for indicating the transmission operating states “Park” and “Neutral”. The parking lock system further comprises an emergency release mechanism for the parking lock that can be triggered when the internal combustion engine of the vehicle is turned off, which emergency release mechanism activates an electric motor that can be operatively connected to the internal combustion engine and to a pump of the transmission upon the occurrence of a defined event, in order to disengage the parking lock in a pressure-controlled manner.

DE 10 2018 219 809 A1 relates to a method for avoiding locally occurring imminent hazards, in which an avoidance route is calculated for a vehicle in order to avoid the imminent hazard. In this case, a message concerning the imminent hazard is received by the vehicle. The vehicle then performs a hazard potential assessment in relation to the imminent hazard reported and, if the hazard potential assessment indicates a serious hazard potential, the vehicle independently initiates driving along the avoidance route in order to avoid the imminent hazard.

US 2018/158255 A1 discloses an information display with a display screen on a vehicle, wherein the display screen is configured to show visual information based on a vehicle mode in which the vehicle is operating. The display may also show instructions for connecting to a communication interface of the vehicle, wherein the vehicle operates in a vehicle mode based on the occurrence of one or more events associated with the vehicle.

US 2020/247420 A1 discloses a system for controlling a vehicle based on driver interaction, wherein a method for controlling a vehicle may comprise: determining a driver state estimation of a driver of the vehicle using driver data from one or more driver sensors; determining one or more environmental anomalies using environmental data from one or more environmental sensors within an environment of the vehicle; and determining an anomaly category for at least one of the one or more environmental anomalies. Based on the driver state estimation and one or more anomaly categories, the method also comprises a fault mode selection and, based on the fault mode, a selection of at least one fail-safe action, and determination of a vehicle operation in accordance with the fault mode.

EP 3 644 295 A1 discloses an operating terminal for presenting display information. In this case, first information, including operational information, is exchanged via a first communication path, and second information is exchanged via a second communication path, wherein the second information comprises the display information relating to a parking control. If a first evaluation value of the first communication path is smaller than a first threshold value, at least part of the first information is exchanged via one or more communication paths other than the first communication path. If a second evaluation value of the second communication path is smaller than a second threshold, at least part of the second information is exchanged via one or more communication paths other than the second communication path, and the data volume of the first information and/or the second information is reduced. A vehicle is parked in accordance with a control instruction for moving along a parking route, wherein the control instruction is based on operational information input into the external operating terminal.

None of the aforementioned disclosures provides the core concept of an operational mode for an at least partially automated vehicle with an automated system, in which, in the event of serious malfunctions in the automated system, once the error has been detected and a fail-safe response executed, the vehicle is placed in a recovery mode to enable safe retrieval of the vehicle, for example from an inaccessible area.

There is therefore a need to ensure that an automated vehicle can be safely recovered in the event that it becomes immobilized in an area that is inaccessible.

### SUMMARY

In an embodiment, the present disclosure provides a method for recovering at least a partially automated vehicle comprising a vehicle control system. The vehicle control system includes at least a first subunit and a second subunit, wherein the method includes: detecting a malfunction in at least part of the first subunit of the vehicle control system; checking whether the first subunit is in an emergency operating state, and, based on determining that the first subunit is not in an emergency operating state, transitioning the first subunit or the vehicle control system into an emergency operating state; controlling the vehicle in the emergency operating state based on the emergency operating state with help from the vehicle control system; receiving a release signal via the vehicle control system; and actuating the first subunit or the second subunit of the vehicle control system based on the release signal.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic depiction to illustrate a first exemplary embodiment of the vehicle control system according to the invention;

FIG. 2 shows a schematic depiction to illustrate a second exemplary embodiment of the vehicle control system according to the invention;

FIG. 3 shows a schematic depiction to illustrate a braking system with a recovery operation unit in accordance with the present invention;

FIG. 4 shows a schematic depiction to illustrate a second braking system with a recovery operation unit according to the present invention;

FIG. 5 shows a monostable valve for use in a vehicle with the vehicle control system according to the invention;

FIG. 6 shows a bistable valve for use in a vehicle with the vehicle control system according to the invention;

FIG. 7 shows a solenoid valve for use in a vehicle with the vehicle control system according to the invention; and

FIG. 8 shows a schematic flowchart of a first exemplary embodiment of the method according to the invention for recovering an at least partially automated vehicle.

### DETAILED DESCRIPTION

The aim of this invention is to define a concept for an emergency recovery operation to enable efficient recovery of a stranded automated vehicle located in an area that is difficult or impossible to access by human operators or towing services. Causes of a stranding of this kind are, above all, actuator malfunctions or other internal fault conditions that partially or completely prevent the normal, or even degraded, execution of a planned route, whether generated internally or externally.

In this case, the focus of the invention is primarily on open-pit and underground mining applications, where vehicles are deployed in areas that are inaccessible to human workers due to external hazards, for example. In this case, a stranded vehicle would result in a permanent or long-term loss of the vehicle, or may require a complex and costly aerial recovery. In addition, the vehicle could obstruct or interfere with the automated operation of other vehicles. However, the invention may also facilitate the recovery of automated vehicles in highway automation scenarios on motorways.

The Embodiments of the present disclosure provide a method for recovering an at least partially automated vehicle, in particular one that is stranded, particularly from an area that is inaccessible to humans.

Embodiments of the present disclosure provide a method of the kind referred to above, having the features of claim 1, wherein the vehicle to be recovered comprises a vehicle control system with at least a first subunit and a second subunit, wherein the method comprises the following steps: a) detecting a malfunction in at least part of the first subunit of the vehicle control system, b) checking whether the first subunit is in an emergency operating state, and, if the first subunit is not in an emergency operating state, transitioning the first subunit or the vehicle control system into an emergency operating state, c) controlling the vehicle in emergency mode based on the emergency operating state with the help of the vehicle control system, d) receiving a release signal via the vehicle control system, and e) actuating the first subunit and/or the second subunit of the vehicle control system based on the release signal.

The vehicle may be a partially automated vehicle or a fully automated vehicle. The vehicle is preferably a fully automated vehicle.

The vehicle control system is configured to control the vehicle in an at least partially automated, preferably fully automated, manner.

The vehicle control system of the at least partially automated vehicle comprises subunits. The vehicle control system preferably comprises more than the first subunit and the second subunit. For example, the vehicle control system may comprise a brake control unit, a transmission control unit, a steering control unit, an engine control unit, a monitoring unit, and/or an interface unit. The vehicle control system preferably comprises at least a brake control unit with a service brake and a parking brake. The service brake is substantially configured to decelerate a vehicle that is in motion. The service brake preferably acts on all of the wheels of a vehicle. The parking brake is substantially configured to prevent a vehicle that is not moving from moving. When engaged, a parking brake preferably permanently blocks the wheels of a vehicle to which the parking brake is operatively connected.

The first subunit is a subunit of the vehicle control system. The first subunit is preferably a brake control unit, a transmission control unit, a steering control unit, an engine control unit, a monitoring unit, and/or an interface unit. The second subunit is also a subunit of the vehicle control system. The second subunit is preferably a brake control unit, a transmission control unit, a steering control unit, an engine control unit, a monitoring unit, and/or an interface unit. For example, the first subunit may correspond to the second subunit.

In a first step of the method according to the invention, a malfunction is detected in at least part of a subunit of the vehicle control system, i.e. the first subunit. The malfunction can preferably be detected by a monitoring unit of the vehicle control system.

The method according to the invention preferably relates to the detection of a malfunction in at least part of a subunit of the vehicle control system that may be necessary for driving the vehicle, in particular for safe and/or automated driving of the vehicle.

The malfunction may affect a subunit of the vehicle control system of the vehicle, wherein, in particular, the malfunction may also affect only part of one of the subunits of the vehicle control system, preferably part of a brake control unit, a transmission control unit, a steering control unit, an engine control unit, a monitoring unit, and/or an interface unit.

In the event of a malfunction, control, i.e. driving, of the vehicle is preferably still possible, albeit in a restricted mode compared with the normal state of the vehicle control system. Alternatively, in the event of a malfunction, control of the vehicle in the normal state of the control system may still be possible for a limited period of time, wherein the limited period of time is defined by the nature of the malfunction. As another alternative, in case of a malfunction, control of the vehicle may be prevented by the malfunction.

In a second step of the method according to the invention, it is checked whether the subunit in which the malfunction is detected, i.e. the first subunit, is in an emergency operating state. In particular, when a malfunction is detected for the first time, the first subunit or the vehicle control system is placed in an emergency operating state. An emergency operating state is a state in which control of the vehicle is only possible to a limited extent, the limitation being based on the malfunction. The emergency operating state may also be referred to as a Minimal Risk Maneuver mode or MRM mode. The limitation in this case may be functional and/or temporal. The emergency operating state may apply to only a part of the first subunit, the first subunit, or the vehicle control system. If the entire vehicle control system is in the emergency operating state, the first subunit, in particular also the part of the first subunit, is therefore also in the emergency operating state.

In a third step of the method according to the invention, the vehicle is controlled in emergency mode based on the emergency operating state with the help of the vehicle control system. The emergency control preferably involves executing a “Minimal Risk Maneuver.” For example, the vehicle is controlled in such a manner that the safety of the vehicle and/or other road users is not endangered. The term “other road users” also includes other autonomously driven vehicles. The vehicle is preferably only controlled in emergency mode until it can be safely brought to a stop, i.e. until the vehicle can be safely parked. The term “safe” means that, following a risk assessment, maximum safety for the vehicle and/or other road users is aimed for. In this context, “safe” therefore means that the vehicle is brought to a standstill at a location that provides maximum safety for the vehicle and/or other road users compared with other locations. Safe stopping is particularly defined by neither the vehicle being recovered nor other vehicles or road users being exposed to any risk.

In a fourth step of the method according to the invention, a release signal is received by the vehicle control system, wherein the release signal is transmitted to the vehicle being recovered by a transmitting unit, for example a vehicle control station configured to monitor the operation of automated vehicles, or by a near-field remote control, or in another manner. The release signal is preferably received by an interface unit of the vehicle control system. In a subsequent step, the release signal places the vehicle in a recovery state in which certain functions are released, in order to allow the vehicle to be recovered.

The release signal is, for example, transmitted by a transmitting unit to the vehicle. A communication link between the transmitting unit and the vehicle is preferably secured against external attacks and malfunctions in this case.

The release signal comprises a signal for actuating one subunit or multiple subunits of the vehicle control system. The release signal preferably comprises a signal for actuating one or more subunits that prevent active or passive further movement of the vehicle. For example, the release signal comprises a signal to actuate a brake unit, particularly preferably a parking brake, to release the brake unit and/or parking brake. In addition or alternatively, the release signal may also comprise a signal for actuating a drivetrain and/or a transmission to disengage the drivetrain and/or the transmission.

Steps 1 through 4 may be understood as preconditions that transition the vehicle into a safe state (MRM mode).

In a fifth step of the method according to the invention, the first subunit and/or the second subunit is actuated based on the release signal. For example, the release signal may comprise a release signal for an actuator of one of the subunits of the vehicle control system, such as an actuator of a parking brake that had been engaged after the vehicle came to a standstill.

The method according to the invention enables a specific recovery operation or recovery mode (rescue mode) of a stranded automated vehicle, wherein the recovery mode is triggered externally, that is, from outside the vehicle. As a result, a recovery of the automated vehicle, particularly from areas inaccessible to humans, is made possible.

Recovery of a stranded vehicle is preferably carried out when the MRM mode has already been executed, the vehicle is stationary, particularly secured, and an automation interface is closed.

In a preferred embodiment, the malfunction detected in the first step of the method is a malfunction that prevents the vehicle from continuing to drive safely. This has the advantage that the above method for recovering the vehicle is only carried out when safe operation of the automated vehicle can no longer be guaranteed.

The fifth step of the method according to the invention may be understood as placing the vehicle in a recovery state or rescue mode based on the release signal.

In another preferred embodiment, emergency control in the emergency operating state, i.e. the MRM mode, of the vehicle and/or in the rescue mode involves bringing the vehicle to a standstill, particularly preferably to an emergency stop. Accordingly, following detection of a malfunction and transition into an emergency operating state, the vehicle is initially brought to a standstill as part of a “Minimal Risk Maneuver”, for example, wherein the stopping operation takes account both of the safety of the vehicle and the safety of other road users, wherein the vehicle can then be recovered, following receipt of a release signal, by actuating the first subunit or second subunit (rescue mode). This increases the safety of the vehicle and/or other road users when recovering the vehicle. The emergency stop preferably involves engaging or maintaining engagement of a parking brake and/or deactivating an automation interface, so that autonomous operation of the vehicle can be inhibited. In other words, the emergency stop may involve engaging a parking brake and/or deactivating at least part of the vehicle control system, wherein said part of the vehicle control system is configured to control the vehicle in an at least a partially automated manner.

In addition or alternatively, actuating the first subunit or the second subunit of the vehicle control system based on the release signal may include a stop, in particular an emergency stop, i.e. as part of the rescue mode, as described above. Particularly preferably, a stop or emergency stop during the rescue mode is independent of an emergency operating state, in particular an emergency stop during the emergency operating state (MRM mode).

For example, actuating the first subunit or the second subunit may involve releasing or disengaging a parking brake. This enables the vehicle (in rescue mode) to be towed, in particular, for example by another vehicle, preferably a (fully) automated vehicle.

In addition or as an alternative to towing, following actuation of the first subunit or the second subunit, the vehicle may be controlled by the vehicle control system (in rescue mode), wherein the vehicle is then preferably controlled from outside based on control signals included in the release signal. The method according to the invention therefore preferably comprises the step of controlling the vehicle based on the control signals after actuating the first subunit and/or second subunit. In other words, the method comprises the step of receiving control signals, wherein the vehicle is controlled, in particular remotely, based on the control data following actuation of the first subunit or the second subunit. Remote control may be carried out from outside the vehicle, i.e. by a transmitting unit, such as a vehicle control station, depending on the malfunction and/or depending on the release signal.

In a further preferred embodiment, the method includes the additional step of monitoring the malfunction and/or monitoring the towing or control of the vehicle. More preferably, the monitoring step is carried out by a transmitting unit outside the vehicle.

More preferably, during control of the vehicle following actuation of the first subunit or the second subunit, the vehicle is operated in a restricted operating mode compared with the normal operating mode of the vehicle, which may also be referred to as the rescue mode, may form part of such a mode, or may encompass it. In this case, the restricted operating mode is preferably a dynamically restricted operating mode, i.e. it can be configured to a respective situation. A dynamically restricted operating mode allows for further intervention in the control of the vehicle, particularly from outside the vehicle, while the vehicle is being controlled.

It is conceivable that, due to the malfunction, at least part of the first subunit is non-operational, meaning the vehicle is not fully functional, which reduces the safety of the vehicle and/or other road users. By using a restricted vehicle operating mode in which riskier driving maneuvers are not possible, for example, the safety of the vehicle and/or other road users is further improved.

While the vehicle, i.e. the vehicle control system or at least the first subunit, is in a recovery mode (rescue mode), it is preferred that a communication link, preferably a wireless link, between the vehicle and a transmitting unit (e.g. a control station from which the release signal is sent) is actively monitored, and, if a connection between the vehicle and the transmitting unit is lost, the recovery mode of the vehicle, i.e. of the vehicle control system, is terminated. Termination of the recovery mode in the event that the vehicle is being controlled by the transmitting unit based on control signals included in the release signal, following actuation of the first or second subunit, preferably results in the vehicle being brought to a standstill, with safe stopping being prioritized. This ensures that, in the event that the vehicle no longer receives control input from outside, the vehicle is brought to a standstill, preferably in a safe manner. This further increases the safety of the vehicle during the recovery process.

In one embodiment, in which the towing or control of the vehicle, i.e. control following actuation of the first subunit and/or second subunit, preferably in rescue mode, is already being monitored, an error detected as occurring during towing or control may result in the vehicle being transitioned into a safe state, preferably being brought to a standstill. For example, it is then provided that the vehicle receives an emergency stop signal, for example from the transmitting unit, and comes to a standstill based on the emergency stop signal. An emergency stop signal may also be manually triggered by an operator via a switch on the vehicle or remotely via a remote control. An emergency stop signal can also be automatically issued by the vehicle in rescue mode if a critical fault occurs.

Alternatively, control of the vehicle (in rescue mode), e.g. based on control signals from the transmitting unit, can be terminated via a dedicated emergency stop signal from the transmitting unit.

In a preferred embodiment, the actuation of the first subunit or the second subunit (in rescue mode) involves actuating at least one actuator of the first subunit or the second subunit. For example, by actuating one, some, or all actuators of the first subunit and/or one, some, or all actuators of the second subunit, targeted recovery of the vehicle, for example either by subsequently towing the vehicle or by remotely controlling the vehicle, can be enabled.

When actuating the actuators, it is particularly preferable to minimize the number of actuators being actuated. In particular, “minimizing” refers to mathematical minimization, meaning that the number of changes from one state of the actuator to a (different) state of the actuator, in which the vehicle can be recovered, is reduced to a minimum. Since the actuation of the actuators is based on the release signal, and the release signal is preferably transmitted from outside the vehicle, minimizing the number of actuators being actuated minimizes the data load of the release signal. Furthermore, actuating as few actuators as possible reduces the susceptibility to error of the recovery process.

In a preferred embodiment, the release signal is received via a V2X communication, wherein a V2X communication enables a data exchange between the vehicle being recovered and any transmitting unit in the vicinity of the vehicle being recovered. By way of example, the transmitting unit may also be a vehicle, in which case the V2X communication becomes a V2V communication, wherein a V2V communication allows for a data exchange between the vehicle being recovered and one or more additional vehicles in the vicinity of the vehicle. The V2X or V2V communication is preferably a wireless communication, particularly preferably 5G.

In a further preferred embodiment, the method according to the invention comprises, following detection of the malfunction in at least part of the first subunit, providing and/or transmitting fault data, wherein the fault data is indicative of the malfunction. This enables analysis of the malfunction affecting the automated vehicle from outside the automated vehicle. Furthermore, providing and/or transmitting the fault data enables the first subunit or the vehicle control system to be placed in an emergency operating state, for example the MRM mode, from outside, for example from a vehicle control station.

In the above variant, the release signal transmitted from the transmitting unit is preferably based on the fault data previously received by the transmitting unit. In other words, depending on the nature of the malfunction, a release signal may be selected for transmission to the vehicle control system, depending on which fault occurs in the vehicle control system. This malfunction-dependent release signal may be received by the vehicle to be recovered and then used accordingly to actuate the first subunit and/or the second subunit (in rescue mode). This allows for systematic classification/categorization of faults and the release signals and/or control signals to be transmitted as a result. In this way, a specific action, i.e. a targeted actuation of one or more actuators (in rescue mode), can be performed based on a specific fault.

In a particularly preferred embodiment, actuating the first subunit and/or the second subunit (in rescue mode) enables the vehicle to be towed. Following emergency control of the vehicle, the vehicle settings that prevent towing, particularly engagement of the brake unit, for example activation of the parking brake or activation of the transmission unit, can be modified so that a brake, for example a parking brake, is released, or the transmission is shifted into neutral. In other words, the method according to the invention may include the step of towing the vehicle by actuating the first subunit or the second subunit.

In general, it is preferred that the actuation of the first subunit and/or the second subunit (in rescue mode) includes actuating a parking brake, wherein the parking brake is brought into a released state by actuation based on the release signal.

Particularly preferably, the actuation of the parking brake includes actuating an anti-compound port, an emergency release port, a select-high valve, and/or a spindle drive. In addition or alternatively, actuation includes controlling solenoid valves. In this case, actuation of the parking brake preferably includes actuating a monostable valve and a bistable valve.

In addition or as an alternative to actuating a parking brake, the actuation of the first subunit and/or the second subunit may include actuating a drivetrain and/or a transmission. In this case, the drivetrain and/or the transmission is moved into a disengaged state through actuation based on the release signal.

According to a further aspect of the invention, a vehicle control system with a brake control unit, a transmission control unit, a steering control unit, an engine control unit, a monitoring unit, and an interface unit is described, wherein the interface unit is configured to execute the method according to one of the above embodiments, and wherein the first subunit and the second subunit each correspond to one of the brake control unit, the transmission control unit, the steering control unit, the engine control unit, the monitoring unit, and the interface unit.

In a preferred embodiment, the interface unit comprises a power supply unit that is in addition to a power supply unit of the vehicle control system. This has the advantage that, in the event that the malfunction affects the power supply unit of the vehicle control system, the recovery process of the vehicle (in rescue mode) can still be guaranteed.

In a further preferred embodiment, the interface unit comprises a recovery operation unit, wherein the recovery operation unit is configured to actuate the first subunit and/or the second subunit of the vehicle control system based on the release signal. The recovery operation unit also preferably comprises a power supply unit that is in addition to the power supply unit of the vehicle control system. In the event that both the interface unit and the recovery operation unit are provided with a power supply unit in addition to the power supply unit of the vehicle, the power supply unit of the interface unit and the power supply unit of the recovery operation unit may be identical.

In a preferred embodiment, the second subunit comprises an additional actuator emergency unit or an additional actuator, which is provided in addition to actuators of the vehicle intended for normal vehicle operation, and is electrically independent of the actuators of the vehicle provided for normal operation of the vehicle. The additional actuator emergency unit or additional actuator is preferably not used during normal vehicle operation.

Particularly preferably, the second subunit comprises a parking brake, wherein the parking brake is moved into a released state through actuation based on the release signal.

It is particularly preferable in this case for the parking brake to comprise a brake pressure supply unit that is in addition to a brake pressure supply unit of the brake control unit. This ensures that, even in the event of a malfunction of the brake pressure supply unit of the brake control unit, the release of the parking brake to allow recovery of the automated vehicle can still be guaranteed.

Particularly preferably, the parking brake comprises emergency release units, wherein the emergency release units are provided in addition to a release unit of the parking brake. The emergency release units are preferably not used to release the parking brake during normal operation of the vehicle. For example, the emergency release units may comprise solenoid valves, wherein a release of the parking brake, for example in MRM mode or rescue mode, corresponds to a release of the solenoid valves.

Particularly preferably, the parking brake comprises solenoid valves, wherein releasing the parking brake corresponds to activating the solenoid valves. In this case, a solenoid valve may be a monostable valve or a bistable valve. This allows for particularly simple actuation of the parking brake to release said parking brake.

Embodiments of the invention are described below with reference to the drawings. These drawings are not necessarily to scale; rather, they are presented in a schematic and/or slightly distorted manner where helpful for explanation. With respect to any enhancements to the teachings that are directly apparent from the drawings, reference is made to the relevant prior art. It should be noted that various modifications and changes relating to the shape and details of an embodiment can be made without departing from the general concept of the invention. The features disclosed in the description, in the drawings, and in the claims may be essential to the development of the invention, both individually and in any combination. Furthermore, all combinations of at least two features disclosed in the description, drawings, and/or claims fall within the scope of the invention. The general idea of the invention is not limited to the exact form or detail of the preferred embodiments shown and described below, nor too is it limited to subject matter that would be narrower than that defined in the claims. Where dimensional ranges are indicated, the values lying within those limits are considered to be disclosed as limit values and may be freely applied and claimed as such. For the sake of simplicity, identical reference signs are used below for identical or similar parts, or parts with identical or similar functions.

Further advantages, features, and details of the invention will become apparent from the following description of preferred embodiments and with the help of the drawings.

In the attached drawings and the explanations thereof, elements corresponding to or associated with one another—where appropriate—are indicated using identical or similar reference signs in each case, even when they are to be found in different exemplary embodiments.

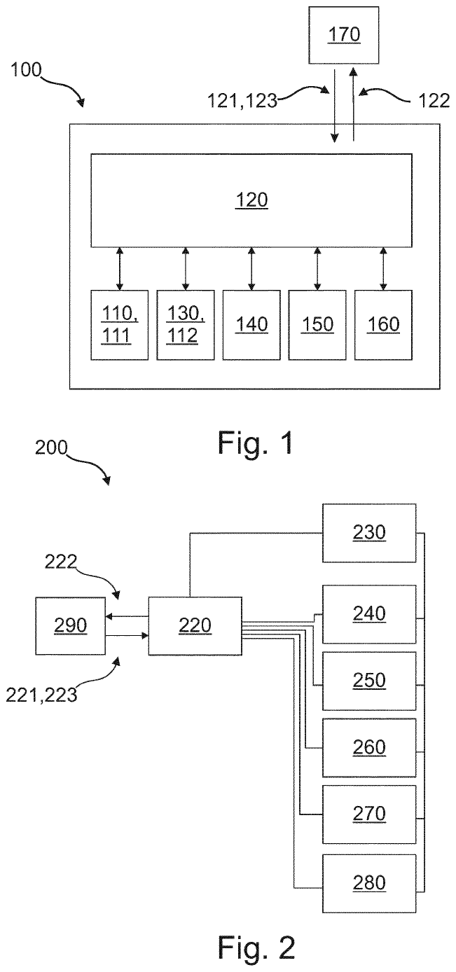

FIG. 1 shows a schematic depiction to illustrate a first exemplary embodiment of the vehicle control system 100 according to the invention. The vehicle control system 100 may be installed in a vehicle 300, 400. The vehicle control system 100 comprises a brake control unit 110, a transmission control unit 130, a steering control unit 140, an engine control unit 150, a monitoring unit 160, and an interface unit 120. The brake control unit 110 is configured to control braking of the vehicle 300, 400, at least partially, and preferably fully, in an automated manner. The transmission control unit 130 is configured to control a transmission of the vehicle 300, 400, at least partially, and preferably fully, in an automated manner. The steering control unit 140 is configured to control steering of the vehicle 300, 400, at least partially, and preferably fully, in an automated manner. The engine control unit 150 is configured to control an engine of the vehicle 300, 400, at least partially, and preferably fully, in an automated manner. The monitoring unit 160 is configured to monitor the condition of at least part of a subunit, a subunit, or the vehicle control system 100. The interface unit 120 is configured to transmit signals 122 and to receive signals, in particular a release signal 121 or a control signal 123.

In the example shown in FIG. 1, the brake control unit 110 serves as the first subunit 111, and the transmission control unit 130 serves as the second subunit 112. Alternatively, any of the other subunits of the vehicle control system 100 may correspond to the first subunit 111, and any of the other subunits of the vehicle control system 100 may correspond to the second subunit 112.

The interface unit 120 is configured to implement the method according to the invention for recovering an at least partially automated vehicle 300, 400 using the vehicle control system 100; in other words, the vehicle control system 100 is configured to detect a malfunction in at least part of a first subunit 111 of the vehicle control system 100, to check whether the first subunit 111 is in an emergency operating state, and, if the first subunit 111 is not in an emergency operating state, to move the first subunit 111 or the vehicle control system 100 into an emergency operating state, to control the vehicle 300, 400 in emergency mode based on the emergency operating state using the vehicle control system 100 (MRM mode), to receive a release signal 121 via the vehicle control system 100, and to actuate the first subunit 111 or the second subunit 112 of the vehicle control system 100 based on the release signal 121 (rescue mode).

In this exemplary embodiment, the monitoring unit 160 of the vehicle control system 100 is configured to detect a malfunction in at least part of a first subunit 111. Furthermore, the monitoring unit 160 is configured to determine whether the first subunit 111 is in an emergency operating state and, in the event that the first subunit 111 is not in an emergency operating state, to place the first subunit 111 or the vehicle control system 100 in an emergency operating state, for example MRM mode. In addition, the brake control unit 110, the transmission control unit 130, the steering control unit 140, and the engine control unit 150 are configured to control the vehicle 300, 400 in emergency mode based on the emergency operating state (MRM mode). The interface unit 120 of the vehicle control system 100 is further configured to receive a release signal 121. The release signal 121 in this case may be transmitted from a transmitting unit 170, for example a vehicle control center located outside the vehicle 300, 400. The vehicle control system 100 is configured to actuate one of the subunits, for example the subunits 111, 112, of the vehicle control system 100 based on the release signal 121 (rescue mode).

In the vehicle control system 100, the first subunit 111 is the brake control unit 110, and the second subunit 112 is the transmission control unit 130. However, it is also conceivable that the first subunit 111, in addition or as an alternative to the brake control unit 110, comprises the transmission control unit 130, the steering control unit 140, the engine control unit 150, and/or the monitoring unit 160. Furthermore, in the vehicle control system 100, the second subunit 112 is the transmission control unit 130, wherein the second subunit 112 may, in addition or as an alternative to the transmission control unit 130, comprise the brake control unit 110, the steering control unit 140, the engine control unit 150, and/or the monitoring unit 160. In another example according to the invention, the first subunit 111 may correspond to the second subunit 112.

It is preferable for the malfunction of at least part of the first subunit 111 to result in the vehicle 300, 400 being prevented from continuing to run safely. It is further preferable for the vehicle control system 100, in particular the brake control unit 110, the transmission control unit 130, the steering control unit 140, and/or the engine control unit 150, to be configured to bring the vehicle 300, 400 to a standstill based on the emergency operating state. Additionally or alternatively, it is preferable for the vehicle 300, 400 to be controlled by the vehicle control system 100, following activation of the first subunit 111 or the second subunit 112, in a restricted operating mode compared with a normal operating mode of the vehicle 300, 400, in particular in a dynamically restricted operating mode.

In one example, the interface unit 120 may be configured to monitor a connection between the vehicle 300, 400 and the transmitting unit 170, from which the release signal 121 is sent, wherein the connection may be a wireless communication link. For example, the vehicle control system 100 may be configured to terminate control of the vehicle 300, 400 if a connection between the vehicle 300, 400 and the transmitting unit 170 is lost.

The interface unit 120 may be configured to receive the release signal 121 via a V2X communication, particularly a wireless communication.

In addition, the interface unit 120 may be configured, following detection of the malfunction of at least part of the first subunit 111 by the monitoring unit 160, to provide and/or transmit fault data 122 that is indicative of the malfunction, in particular to the transmitting unit 170. The release signal 121 is preferably based on the fault data 122, meaning that the release signal 121 is generated based on the fault data 122 and transmitted to the interface unit 120.

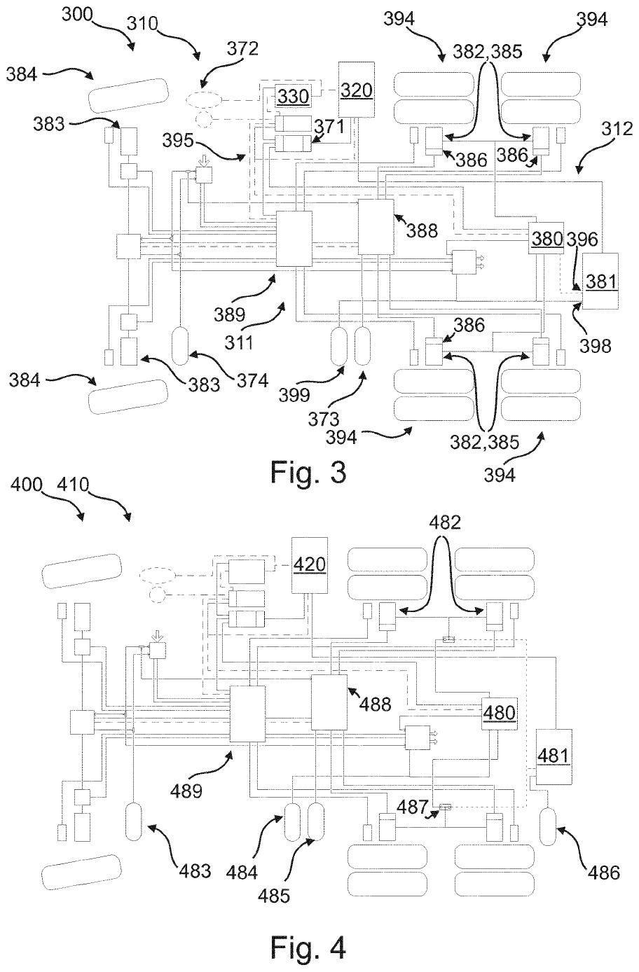

The vehicle control system 100 is preferably configured to enable towing of the vehicle 300, 400 following actuation of the first subunit 111 or the second subunit 112. Particularly preferably, the brake control system 110 comprises a parking brake 380, 480, as shown in FIGS. 3 and 4, for example, in connection with the braking systems 310 and 410, wherein, upon actuation of the first subunit 111 or the second subunit 112, the parking brake 380, 480 is actuated, wherein, through actuation based on the release signal 121, the parking brake 380, 480 is brought into a released state.

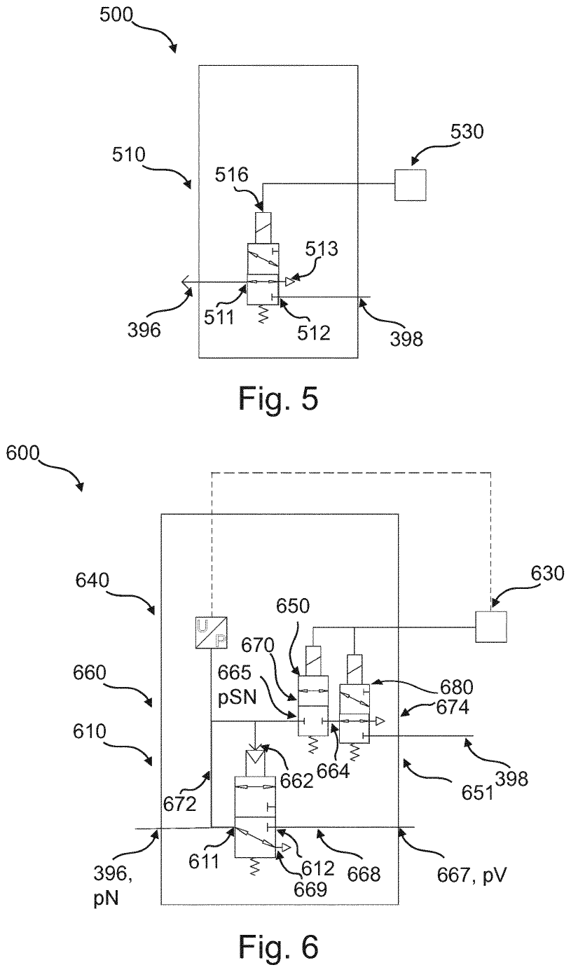

In one example, in which the vehicle control system 100 is configured to actuate the parking brake 380, 480 and bring it into a released state after a malfunction has been detected, it is preferred that an anti-compound port, an emergency release port, a select-high valve, and/or a spindle drive is actuated. In addition or alternatively, a monostable valve or a bistable valve may be actuated when actuating the parking brake 380, 480, as shown in FIGS. 5 and 6, for example.

In addition or as an alternative to the actuation of the parking brake 380, 480, the vehicle control system 100 may be configured to actuate a drivetrain and/or a transmission, as provided in the transmission control unit 130 and the engine control unit 150, respectively. Upon actuation, the drivetrain and/or the transmission in each case is placed in a disengaged state based on the release signal 121.

FIG. 2 shows a schematic depiction to illustrate a second exemplary embodiment of the vehicle control system 200 according to the invention. The vehicle control system 200 may be installed in vehicle 300 or 400, for example. In particular, FIG. 2 shows an interface unit 220. The interface unit 220 is configured to receive release signals 221 and control signals 223. In addition, the interface unit 220 is configured to send emergency recovery requests 222, i.e., following detection of the malfunction, an emergency recovery request 222 is sent to a transmitting unit 270, whereupon the transmitting unit 270 transmits release signals 221 and/or control signals 223, and the interface unit 220 receives the release signals 221 and/or control signals 223.

The interface unit 220 shown in FIG. 2 is connected via emergency paths to additional subunits which preferably have actuators. In this example, the interface unit 220 is connected to a monitoring unit 230, an emergency unit for automatic control 240, an emergency-release parking brake 250, an emergency drivetrain and engine control unit 260, an emergency steering unit 270, and an emergency braking unit 280. In addition, in this embodiment, the monitoring unit 230, the emergency unit for automatic control 240, the emergency-release parking brake 250, the emergency drivetrain and engine control unit 260, the emergency steering unit 270, and the emergency braking unit 280 are interconnected. The vehicle control system 200 is configured to detect a malfunction in at least part of one of the monitoring unit 230, the emergency unit for automatic control 240, the emergency-release parking brake 250, the emergency drivetrain and engine control unit 260, the emergency steering unit 270, and/or the emergency braking unit 280 of the vehicle control system 200, and to determine whether the unit with the malfunction is in an emergency operating state. In the event that the unit experiencing the malfunction is not in an emergency operating state, the unit with the malfunction or the entire vehicle control system 200 is configured to be placed in an emergency operating state. In particular, the vehicle control system 200 is configured to control the vehicle 300, 400 in emergency mode based on the emergency operating state. Furthermore, the vehicle control system 200 is configured to receive a release signal 221 via the interface unit 220, and to actuate one or more of the monitoring unit 230, the emergency unit for automatic control 240, the emergency-release parking brake 250, the emergency drivetrain and engine control unit 260, the emergency steering unit 270, and the emergency braking unit 280, in particular one or more actuators assigned to a respective subunit, based on the release signal 221. Preferably, the emergency-release parking brake 250, and more preferably at least one actuator of the emergency-release parking brake 250, is actuated.

The following are further considerations regarding exemplary embodiments of the vehicle control system according to the invention.

For example, a vehicle control system according to the invention for controlling and recovering an at least partially automated vehicle comprises a first subunit and a second subunit, wherein the vehicle control system is configured to control the vehicle in an at least partially automated manner using at least the first subunit, and is further configured, in the event of a malfunction in at least part of one of the subunits, to place the vehicle control system, or at least one of the first and second subunits, in an emergency operating state and to control the vehicle in emergency mode based on that emergency operating state (MRM mode). Furthermore, the vehicle control system comprises an interface unit configured to receive a release signal and to actuate at least the second subunit of the vehicle control system based on the release signal (rescue mode). Preferably, the interface unit is also configured to control the automated vehicle based on the release signal. Particularly preferably, the interface unit is further configured to control the automated vehicle based on the release signal in a restricted operating mode, in particular a dynamically restricted operating mode, compared with a normal operating mode of the vehicle.

For example, the second subunit comprises a vehicle actuator, wherein the interface unit is configured to actuate at least the vehicle actuator of the second subunit. In a case where the second subunit comprises multiple vehicle actuators, the interface unit is preferably configured to minimize a number of vehicle actuators that are being actuated.

The interface unit preferably provides a V2X communication, in particular a wireless communication, and the release signal is communicated via V2X, particularly via wireless communication.

In a preferred embodiment, the interface unit comprises a recovery operation unit, wherein the recovery operation unit is configured to receive the release signal and, based on the release signal, to actuate at least the second subunit. For example, the recovery operation unit comprises a power supply unit that is in addition to a power supply unit of the vehicle control system.

In another preferred embodiment, the vehicle control system comprises a condition monitoring unit configured to monitor a state of at least the first subunit, to detect a malfunction in at least part of the first subunit, and to provide fault data, wherein the fault data is indicative of the malfunction. Furthermore, the interface unit may be configured to transmit the fault data to an external transmitting unit. For example, the release signal is based on the fault data.

In addition, the interface unit may comprise a connection monitoring unit, wherein the connection monitoring unit is configured to monitor a communication between the interface unit and a transmitting unit of the release signal, wherein the interface unit may also be configured to terminate an actuation of the second subunit in the event that a communication link between the interface unit and the transmitting unit is lost.

Actuation based on the release signal preferably allows the vehicle to be towed.

In a preferred embodiment, the second subunit comprises a parking brake, wherein the parking brake is brought into a released state by actuation based on the release signal. For example, the parking brake is released by an emergency release unit, wherein the emergency release unit comprises an emergency release port, a select-high valve, and/or a spindle drive. Particularly preferably, the parking brake comprises a brake pressure supply unit that is in additional to a brake pressure supply unit of a braking system. In addition or alternatively, the emergency release unit comprises a monostable valve or a bistable valve.

In a further preferred embodiment, the second subunit comprises, in addition or as an alternative to a parking brake, a drivetrain and/or a transmission, wherein the drivetrain and/or the transmission is brought into a disengaged state by actuation based on the release signal.

The invention also relates to an electropneumatic braking system for a partially automated vehicle having a parking brake unit which comprises an emergency release unit, wherein the parking brake unit is configured to be placed in an emergency operating state depending on a malfunction of at least part of a vehicle control unit of the vehicle, wherein the braking system comprises an interface unit that is configured to receive a release signal and to actuate the emergency release unit based on the release signal (rescue mode).

FIG. 3 shows a schematic depiction to illustrate a braking system 310 with an interface unit 320, which may be understood as a recovery operation unit, in accordance with the present invention, wherein the braking system 310 is installed in a vehicle 300 with a central control unit 389. The braking system 310 is an electropneumatic braking system. The blocks shown in FIG. 3 and FIG. 4, which are not separately labeled with reference signs, relate to standard components of the braking system 310, such as the overload protection valve, parking release safety valve, axle modulator, wheel speed sensor, brake actuator, etc.

The braking system 310 has a service brake system 311 and a parking brake system 312. The parking brake system 312 has a parking brake 380 in the form of a valve unit with at least one spring chamber port for providing parking brake pressure to actuators 382, which correspond to spring-actuated brake cylinders. In the present case, the vehicle 300 includes four spring-actuated brake cylinders, each assigned to a rear wheel 394. Furthermore, the service brake system 311 has two service brake cylinders 383, which are each assigned to a front wheel 384.

In this case, the spring-actuated brake cylinders are configured as combination brake cylinders 385, meaning that they each have a service brake chamber 386 that can be actuated by brake pressure supplied from the service pressure supply unit 399.

The central control unit 389, which is configured as a service brake control unit for controlling the service brake system 311, is connected to an axle modulator 388, which forms a rear brake circuit as part of the service brake system 311.

The parking brake 380 comprises a parking brake control unit for controlling the parking brake system 312. The parking brake 380 further comprises a parking brake valve unit configured to regulate the parking brake pressure. To supply the parking brake pressure to the actuators 382, i.e. the spring-actuated brake cylinders, the parking brake valve unit has at least one spring chamber port that is pneumatically connected to the actuators 382, i.e. the spring-actuated brake cylinders. The parking brake 380 also has a parking control unit that is configured to provide an electronic parking brake signal for control purposes and is connected to the parking brake valve unit in a signal-conducting manner.

By regulating the parking brake pressure at the spring chamber port in response to the electronic parking brake signal, the spring-loaded brake cylinders are pressurized, thereby releasing a wheel brake that is not shown in detail here. If, on the other hand, the spring-actuated brake cylinders are vented, in other words the parking brake pressure falls below a minimum value, the spring-actuated brake cylinders engage, and the wheels, in this case the rear wheels 394, are braked by the wheel brakes which are not shown in greater detail.

This kind of venting of the spring-actuated brake cylinders may occur particularly during an emergency or fail-safe braking scenario. This situation arises, for example, when a malfunction occurs. In such a case, the vehicle 300 can no longer be moved easily, because the spring-actuated brake cylinders are tensioned and pressurization by the parking brake valve unit is no longer possible due to the malfunction.

In the present case, the parking brake 380 is electrically connected to a power supply 395 for the purpose of being supplied with electrical energy. In the present case, the central control unit 389 is also electrically connected to the power supply 395 to receive electrical energy.

The braking system 310 comprises an emergency release unit 381, i.e. an emergency release valve unit. The emergency release unit 381 is designed to supply an emergency release pressure to the parking brake 380, preferably to the parking brake valve unit.

The emergency release unit 381 is pneumatically connected to an auxiliary brake pressure port for supplying the emergency release pressure via a main port 396, at which the emergency release pressure is regulated. The emergency release unit 381 is pneumatically connected to the brake supply unit 399 via a supply port 398.

The parking brake valve unit and the first control unit are, as shown here, structurally integrated as a single parking brake 380, in this case as a parking brake module.

The braking system 310 also comprises the interface unit 320. In the present embodiment, the interface unit 320 is supplied with electrical power by a power supply 371. Alternatively, the interface unit 320 may also be supplied with electrical power by the power supply 395. The interface unit 320 is connected to the emergency release unit 381 in a signal-conducting manner.

The interface unit 320, which may also be understood as a control unit or over-the-air unit, is connected to an active control unit 372, for example via a bus connection, and enables control of the vehicle, at least following actuation of the actuators. The interface unit 320 is also connected in a signal-conducting manner to a monitoring unit 330 which preferably comprises a virtual driver.

FIG. 4 shows a schematic depiction to illustrate a second braking system 410 in a vehicle 400 with a recovery operation unit 481 in accordance with the present invention. The braking system 410 shown in FIG. 4 substantially corresponds to the braking system shown in FIG. 3; the braking system 410 particularly comprises an interface unit 420, a central control unit 489, an axle modulator 488, a parking brake 480, an emergency release unit 481, and actuators 482. In addition, the braking system includes brake supply units 483, 484, and 485.

Unlike the electropneumatic braking system 310, the electropneumatic braking system 410 comprises an additional brake pressure supply unit 486 for supplying the recovery operation unit 481.

In addition, the emergency release unit 481 is configured to supply emergency release pressure to a shuttle valve 487, i.e. a select-high valve. The shuttle valve 487 is biased to the left in the figure shown. Using the shuttle valve 487, the spring-actuated brake cylinders can be directly pressurized, and thereby released, by means of the emergency release unit 481.

The interface unit 420 is connected to the emergency release unit 481 in a signal-conducting manner.

FIG. 5 shows a monostable valve 500 for use in a vehicle with the vehicle control system according to the invention. The valve 500 may be installed as an emergency release unit in a brake control system, such as the one shown in FIG. 3 or FIG. 4, for example.

In the present case, the monostable valve 500 has a 3/2-way valve 510 in the form of a 3/2-way solenoid valve. The 3/2-way valve 510 has a first emergency release valve port 511 which is pneumatically connected to a main port 396 for supplying emergency release pressure. The 3/2-way valve 510 has a second emergency release valve port 512 which is pneumatically connected to a supply port 398 for receiving a supply pressure, or a pressure provided by an additional brake pressure supply unit. The 3/2-way valve 510 has a third emergency release vent port 513 which is vented to the atmosphere.

In a first emergency release valve position of the 3/2-way valve 510, the first valve port 511 is pneumatically connected to the second valve port 512 to provide a brake pressure available at the supply port 398 as emergency release pressure at the main port 396. In a second emergency release valve position, the first emergency release valve port 511 is pneumatically connected to the emergency release vent port 513, in particular to vent the main port 396 and any ports pneumatically connected thereto.

An electronic emergency release signal can be provided to an electronic control port 516 of the 3/2-way valve 510 by means of a valve control unit 530, which may be associated with a service brake system not shown here, for example the service brake system 311, in order to switch the 3/2-way valve 510 into the first emergency release valve position. In the non-actuated state, i.e. when no electronic emergency release signal is present at the control port 516, the 3/2-way valve 510 is in the second emergency release valve position.

FIG. 6 shows a bistable valve 600 for use in a vehicle with the vehicle control system according to the invention. The valve 600 may be installed as an emergency release unit in a brake control system, such as the one shown in FIG. 3 or FIG. 4.

Compared with the valve 500 shown in FIG. 5, the bistable valve 600 has an emergency release pressure sensor 640 which is pneumatically connected to the main port 396. However, it should be understood that an emergency release pressure sensor 640 may also be employed in the embodiment shown in FIG. 5. The emergency release pressure sensor 640 is designed to determine the emergency release pressure regulated at a first emergency release valve port 611, and to provide a corresponding electronic emergency release pressure signal based on the emergency release pressure determined. In the present case, the emergency release pressure sensor 640 is connected in a signal-conducting manner to a further control unit 630 in order to supply the electronic emergency release pressure signal to the further control unit 630.

Furthermore, the valve 600 has an emergency release pilot assembly 650 and an emergency release main valve arrangement 660. The emergency release main valve arrangement has a main valve 610 which is designed here by way of example as a 3/2-way valve. The emergency release pilot assembly 650 comprises a pilot valve 670 which is arranged in an emergency release pilot path 651, and in the present case is designed as a 2/2-way valve in the form of a 2/2-way solenoid valve. The pilot valve 670 can be controlled via an electronic emergency release signal. The main valve 610 which can be switched pneumatically has a main valve control port 662 which is pneumatically connected to the emergency release pilot path 651 to receive an emergency release pilot pressure. The pilot valve 670 is arranged in the emergency release pilot path 651 between the supply port 398 and the main valve control port 662.

In a first valve position of the pilot valve 670, a second pilot valve port 664, which is connected to the supply port 398 via a further pilot valve 680 (described below), is pneumatically connected to a first pilot valve port 665, which is connected to the main valve control port 662, in order to provide the supply pressure as emergency release pilot pressure at the main valve control port 662. In a second valve position of the pilot valve 670, the supply port 398 is pneumatically disconnected from the main valve control port 662. The pilot valve 670 is designed to switch to the first valve position, depending on the electronic emergency release signal.

In addition, the valve 600 has a supply port 667 at which a reservoir pressure pV is provided. The emergency release main valve arrangement 660 comprises a main path 668 that pneumatically connects the supply port 667 to the main port 396, and in which the main valve 610 is arranged. The first main valve port 612 is pneumatically connected to the main port 396 to provide the emergency release pressure. The second main valve port 612 is pneumatically connected to the supply port 667 to receive the reservoir pressure pV. The main valve 610 comprises a third main valve vent port 669 that vents to the atmosphere.

In a first main valve position of the main valve 610, the first main valve port 611 is pneumatically connected to the second main valve port 612, and the main valve vent port 669 is preferably blocked. In the first main valve position, the reservoir pressure pV is thereby provided as the emergency release pressure pN at the main port 396. In a second main valve position of the main valve 610, the first main valve port 611 is pneumatically connected to the main valve vent port 669, and the second main valve port 612 is preferably blocked. Consequently, in the second main valve position, the supply port 667 is pneumatically disconnected from the main port 396.

The main valve 610 can be pneumatically controlled via the pilot valve 650 in such a manner that, when an emergency release pilot pressure pSN is regulated at the main valve control port 662 by the pilot valve 650 in its first valve position, the main valve 610 switches to the first main valve switching position.

The valve 600 further comprises a pneumatic self-holding path 672 which pneumatically connects the first main valve port 611 to the main valve control port 662. By means of the pneumatic self-holding path 672, the emergency release pressure pN regulated by the main valve 610 at the first main valve port 611 can be advantageously supplied as the emergency release pilot pressure pSN to the main valve control port 662, advantageously independently of the supply pressure provided at the supply port 398. Using a pneumatic self-holding path 672, it is advantageously possible, following a one-time, in particular, short-term, supply of the reservoir pressure pV to the main valve control port 662, to subsequently and continuously regulate the release pressure pN at the main port 396, even if the reservoir pressure pV is no longer being supplied.

Furthermore, the valve 600 comprises a further pilot valve 680 in the form of a 3/2-way valve, in particular a 3/2-way solenoid valve. The further pilot valve 680 and the pilot valve 670 are arranged pneumatically in series in the emergency release pilot path 651. The further pilot valve 680 is designed in the form of a 3/2-way solenoid valve in this case and can be controlled via a first electronic emergency release signal. Unlike the pilot valve 670, the further pilot valve 680 additionally comprises a vent port 674 which is pneumatically connected to the first pilot valve port 665 in the first valve position.

The further pilot valve 680 comprises a first valve position in which the further pilot valve 680 is pneumatically open, i.e. it pneumatically connects the main valve control port 662 to the pilot valve 670. The further pilot valve 680 has a second valve position in which the further pilot valve 680 pneumatically disconnects the main valve control port 662 from the pilot valve 670.

By means of the emergency release pilot arrangement 650 shown here, comprising a pilot valve 670 designed as a 2/2-way valve and a further pilot valve 680, it is advantageously possible to controllably vent an emergency release pilot pressure pSN present at the main valve control port 662, in order to terminate regulation of the emergency release pressure pN at the main port 396. For this purpose, the further pilot valve 680 is advantageously switched into the first valve position and the pilot valve 670 into the second valve position, so that the main valve control port 662 is vented via the vent port 674.

Valves 600 supplied with reservoir pressure pV advantageously allow continuous regulation of an emergency release pressure pN, namely particularly when the reservoir pressure pV is not, or is no longer, present at the supply port 667.

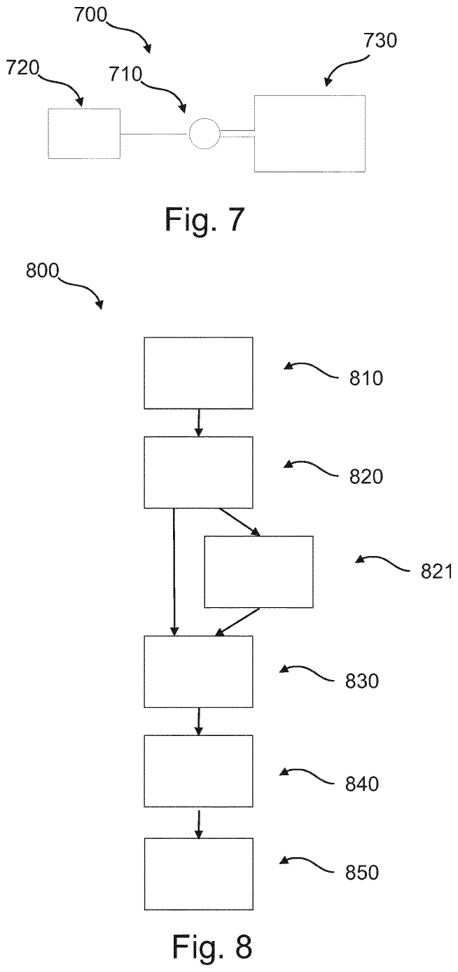

FIG. 7 shows a system 700 with a solenoid valve 710 for use in a vehicle 300, 400 with the vehicle control system 100, 200 according to the invention.

The solenoid valve 710 is connected in a signal-conducting manner to an interface unit 720 which may correspond to one of interface units 120, 220, 320, and 420. Furthermore, the solenoid valve 710 is pneumatically connected to an actuator 730, which may correspond to a spring-actuated brake cylinder 382 or 482, for example. By actuating the solenoid valve 710, the spring-actuated brake cylinders 382 or 482 are pressurized, thereby releasing a parking brake.

FIG. 8 shows a schematic flowchart of a first exemplary embodiment of the method 800 according to the invention for recovering an at least partially automated vehicle 300, 400.

In a first step 810, a malfunction of at least part of the first subunit of the vehicle control system 100, 200 is detected.

In a second step 820, it is checked whether the first subunit is in an emergency operating state. If the first subunit is in an emergency operating state, the next step following step 820 is step 830. If the first subunit is not in an emergency operating state, the first subunit or the vehicle control system 100, 200 is transitioned into an emergency operating state in step 821.

In a next step 830, the vehicle 300, 400 is controlled in an emergency mode (MRM mode) based on the emergency operating state with the help of the vehicle control system 100, 200.

In a following step 840, a release signal is received by the vehicle control system 100, 200, and in a final step 850, the first subunit and/or the second subunit of the vehicle control system 100, 200 is actuated based on the release signal, i.e. in a recovery mode or rescue mode.

Further considerations regarding the invention follow.

The core of the invention is a specific recovery operation for a stranded automated vehicle, which is initiated externally via a wireless interface (V2X, 5G, etc.). The wireless interface may be secured accordingly against misuse and malfunction (cybersecurity encryption and functional safety mechanism). The safety concept provides that, according to the invention, at least the failed/faulty function, or the safe recovery process, is monitored manually from outside, and an emergency stop is executed in the event of a fault. According to the invention, the recovery operation is terminated immediately if the wireless connection is interrupted or if a dedicated emergency stop signal is received. Preferably, the emergency stop signal for the recovery operation may, however, be an additional emergency stop signal and therefore independent of the emergency stop signal from the primary automation system. This ensures that recovery of the vehicle is possible, even in cases where the emergency stop function of the primary automation system is defective.

The actuation in the vehicle may preferably be performed directly via a radio unit or via a recovery operation unit attached thereto.

According to the invention, at least one actuator in the vehicle is brought into a recovery operation state during the recovery process described above, thereby enabling the vehicle to be recovered. Depending on the automation application, fault scenario, and recovery strategy, several actuators or actuator systems may also be switched into a corresponding recovery operation state, however.

Two scenarios may be distinguished between in principle:

In a first scenario, the recovery operation involves bringing the automated vehicle into an operational state that allows automated towing of the vehicle by another recovery vehicle. In this case, the parking brake may be released at a minimum, and, if needed, the drivetrain and/or transmission may be disengaged. In addition, further recovery operation states in other actuator subsystems are conceivable.

In a second scenario, there is a recovery operation in which the automated vehicle is brought into an operational state in which it can be maneuvered into a safe area in an emergency mode by remote control from outside the vehicle, using its remaining functional capabilities and, if needed, additional dynamic limitations.

The wireless communication link and actuation of the recovery state can preferably take place via a separate power supply and can therefore be fault-tolerant to failure of main power supply in the vehicle. Examples of an emergency actuation of the parking brake of this kind are shown in FIGS. 3 and 4, for example. The parking brake is released in this case via an emergency control unit. The emergency control unit in this case can either actuate a dedicated pneumatic port of the parking brake (e.g. an anti-compound port or emergency release port), or, alternatively, act directly on the spring brake chamber via select-high valves.

Depending on the desired robustness/fault tolerance, the emergency control unit can preferably be supplied either from the pneumatic supply circuit of the parking brake or from an independent supply circuit. Furthermore, a distinction may be made between a monostable and bistable implementation of the emergency control unit (as shown in FIGS. 5 and 6). A monostable design is preferably selected (at least in scenario 2), since this ensures that emergency braking can be re-initiated in the event of a fault.

Depending on the configuration, one or more valves may be used to actuate the emergency release pressure. Another technical implementation for an emergency release of the parking brake is also shown in FIG. 7. In this case, the spring of the spring brake chamber is, for example, relaxed by a spindle drive, thereby releasing the parking brake for towing purposes.

Further examples of recovery operation states for other actuator systems may include, for instance, in the automatic control system, a recovery mode that enables optionally dynamically limited remote-controlled actuation of the actuators (e.g. in the event of a defect in a single actuator system, a triggered safety mechanism, or an implausible system state). In addition or alternatively, in a recovery mode of the engine control unit, a transmission may be switched to neutral, the drivetrain in the transmission may be disengaged, the drivetrain may be disengaged, the output shaft may be decoupled, and/or the power transmission may be interrupted at another location, e.g. in the differential, etc.

In addition or alternatively, in a recovery mode the steering unit may comprise a torque-free steering system, a steering system locked in a specific position, and/or an electronic recovery mode for steering.

In addition or alternatively, in a recovery operation the brake unit may comprise a triggered safety mechanism.

Furthermore, the wireless unit or the recovery operation unit attached thereto preferably contains a monitoring unit that detects the remaining functional capability of the vehicle and transmits it via the wireless interface to an external entity, for example to a vehicle control center.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

THE TERMS USED IN THE CLAIMS SHOULD BE CONSTRUED TO HAVE THE BROADEST REASONABLE INTERPRETATION CONSISTENT WITH THE FOREGOING DESCRIPTION. FOR EXAMPLE, THE USE OF THE ARTICLE “A” OR “THE” IN INTRODUCING AN ELEMENT SHOULD NOT BE INTERPRETED AS BEING EXCLUSIVE OF A PLURALITY OF ELEMENTS. LIKEWISE, THE RECITATION OF “OR” SHOULD BE INTERPRETED AS BEING INCLUSIVE, SUCH THAT THE RECITATION OF “A OR B” IS NOT EXCLUSIVE OF “A AND B,” UNLESS IT IS CLEAR FROM THE CONTEXT OR THE FOREGOING DESCRIPTION THAT ONLY ONE OF A AND B IS INTENDED. FURTHER, THE RECITATION OF “AT LEAST ONE OF A, B AND C” SHOULD BE INTERPRETED AS ONE OR MORE OF A GROUP OF ELEMENTS CONSISTING OF A, B AND C, AND SHOULD NOT BE INTERPRETED AS REQUIRING AT LEAST ONE OF EACH OF THE LISTED ELEMENTS A, B AND C, REGARDLESS OF WHETHER A, B AND C ARE RELATED AS CATEGORIES OR OTHERWISE. MOREOVER, THE RECITATION OF “A, B AND/OR C” OR “AT LEAST ONE OF A, B OR C” SHOULD BE INTERPRETED AS INCLUDING ANY SINGULAR ENTITY FROM THE LISTED ELEMENTS, E.G., A, ANY SUBSET FROM THE LISTED ELEMENTS, E.G., A AND B, OR THE ENTIRE LIST OF ELEMENTS A, B AND C. REFERENCE SIGNS (PART OF THE DESCRIPTION)
100, 200 Vehicle control system
110 Brake control unit
111 First subunit
112 Second subunit
120, 220, 320, 420 Interface unit
121, 221 Release signal
122, 222 Fault data
123, 223 Control signal
130 Transmission control unit
140 Steering control unit
150 Engine control unit
160, 230, 330 Monitoring unit
170, 290 Transmitting unit
240 Emergency unit for automatic control
250 Emergency-release parking brake
260 Emergency drivetrain and engine control
270 Emergency steering unit
280 Emergency brake unit
300, 400 Vehicle
310, 410 Brake system
311 Service brake system
312 Parking brake system
320 Interface unit
330 Monitoring unit
371, 395 Power supply
372 Active control
373, 399 Brake supply unit
380, 480 Parking brake
381, 481 Emergency release unit
382, 482 Actuator
383 Service brake cylinder
384 Front wheel
385 Combination brake cylinder
386 Service brake chamber
388, 488 Axle modulator
389, 489 Central control unit
394 Rear wheel
396 Main port
398 Supply port
483, 484, 485 Brake supply unit
486 Additional brake pressure supply unit
487 Shuttle valve
500, 600 Valve
510, 610 3/2-way valve
511 First emergency release valve port
512 Second emergency release valve port
513 Third emergency vent port
516 Electronic control port
530 Valve control unit
610 Main valve
611 First main valve port
612 Second main valve port
630 Additional control unit
640 Emergency release pressure sensor
650 Emergency release pilot valve assembly
651 Emergency release pilot path
660 Emergency release main valve arrangement
662 Main valve control port
664 Second pilot valve port
665 First pilot valve port
667 Supply port
668 Main path
669 Main valve vent port
670 Pilot valve
672 Self-holding path
674 Vent port
680 Further pilot valve
700 Solenoid valve system
710 Solenoid valve
720 Interface unit
730 Actuator
800 Method
810 Detection step
820 Checking step
821 Transition step
830 Emergency control step
840 Receiving step
850 Actuation step
pN Emergency release pressure
pSN Emergency release pilot pressure
pV Supply pressure

1: A method for recovering at least a partially automated vehicle comprising a vehicle control system, wherein the vehicle control system comprises at least a first subunit and a second subunit, wherein the method comprises:
detecting a malfunction in at least part of the first subunit of the vehicle control system;
checking whether the first subunit is in an emergency operating state, and, if based on determining that the first subunit is not in an emergency operating state, transitioning the first subunit or the vehicle control system into an emergency operating state;
controlling the vehicle in the emergency operating state based on the emergency operating state with help from the vehicle control system;
receiving a release signal via the vehicle control system; and
actuating the first subunit or the second subunit of the vehicle control system based on the release signal.

2: The method as claimed in claim 1, wherein the malfunction prevents the vehicle from continuing to drive safely.

3: The method as claimed in claim 1, wherein the control of the vehicle in the emergency operating state based on the emergency operating state comprises a stop of the vehicle.

4: The method as claimed in claim 3, wherein the stop involves engaging a parking brake and/or deactivating at least part of the vehicle control system that is configured to control the vehicle in an at least partially automated manner.

5: The method as claimed in claim 1, wherein actuating the first subunit or the second subunit of the vehicle control system based on the release signal includes a stop.

6: The method as claimed in claim 1, wherein the method further comprises:
following actuation of the first subunit or the second subunit, controlling the vehicle, based on the release signal, in a restricted operating mode compared with a normal operating mode of the vehicle.

7: The method as claimed in claim 6, wherein the method further comprises:
monitoring a communication link between the vehicle and a transmitting unit from which the release signal is sent; and
based on determining that a connection between the vehicle and the transmitting unit is lost, terminating control of the vehicle.

8: The method as claimed in claim 1, wherein the actuation of the first subunit or the second subunit includes actuating at least one actuator of the respective first subunit or second subunit.

9: The method as claimed in claim 7, wherein a number of actuated actuators is minimized.

10: The method as claimed in claim 1, wherein the release signal is received via a V2X communication.

11: The method as claimed in claim 1, wherein the method further comprises:
based on the detection of the malfunction in at least part of the first subunit, providing and/or transmitting fault data, wherein the fault data is indicative of the malfunction.

12: The method as claimed in claim 11, wherein the release signal is based on the fault data.

13: The method as claimed in claim 1, wherein the method further comprises:
based on the actuation of the first subunit or the second subunit, towing the vehicle.

14: The method as claimed in claim 1, wherein actuation of the first subunit or the second subunit includes actuating a parking brake, wherein the parking brake is brought into a released state by actuation based on the release signal.

15: The method as claimed in claim 14, wherein the actuation of the parking brake includes actuating an anti-compound port, an emergency release port, a select-high valve, and/or a spindle drive.

16: The method as claimed in claim 14, wherein the actuation of the parking brake includes actuating a monostable valve or a bistable valve.

17: The method as claimed in claim 1, wherein the actuation of the first subunit or the second subunit includes actuating a drivetrain and/or a transmission, wherein the drivetrain and/or transmission is moved into a disengaged state through actuation based on the release signal.

18: A vehicle control system comprising:
a brake control unit;
a transmission control unit;
a steering control unit;
an engine control unit;
a monitoring unit; and
an interface unit,
wherein the interface unit is configured to execute the method as claimed in claim 1, and wherein the first subunit and the second subunit each correspond to one of the brake control unit, the transmission control unit, the steering control unit, the engine control unit, and the monitoring unit.

19: The vehicle control system as claimed in claim 18, wherein the interface unit comprises a power supply unit that is in addition to a power supply unit of the vehicle control system.

20: The vehicle control system as claimed in claim 18 wherein the interface unit further comprises a recovery operation unit, wherein the recovery operation unit is configured to actuate the first subunit or the second subunit of the vehicle control system based on the release signal.

21: The vehicle control system as claimed in claim 18, wherein the second subunit comprises an additional actuator emergency unit or an additional actuator, which is provided in addition to actuators of the vehicle intended for normal vehicle operation, and is electrically independent of the actuators of the vehicle provided for normal operation of the vehicle.

22: The vehicle control system as claimed in claim 18, wherein the second subunit comprises a parking brake, wherein the parking brake is brought into a released state based on the release signal.

23: The vehicle control system as claimed in claim 22, wherein the parking brake comprises a brake pressure supply unit that is additional to a brake pressure supply unit of a brake control unit.

24: The vehicle control system as claimed in claim 22 wherein the parking brake includes emergency release units provided in addition to a release unit of the parking brake.

25: The vehicle control system as claimed in claim 24, wherein the emergency release units comprise solenoid valves, wherein a release of the parking brake corresponds to a release of the solenoid valves.
